(19) United States
(12) Patent Application Publication
(10) Pub. No.: US 2014/0354028 A1
(43) Pub. Date: Dec. 4, 2014

(54) Inflatable Seat Apparatus with Padded Seat Topper, Floor Base and Relief Valve

(71) Applicant: Edward Francis Carolan, Caledon (CA)

(72) Inventor: Edward Francis Carolan, Caledon (CA)

(21) Appl. No.: 14/223,013

(22) Filed: Mar. 24, 2014

Related U.S. Application Data
(60) Provisional application No. 61/822,010, filed on May 10, 2013.

(51) Int. Cl. A47C 4/54; F16K 15/20; A47C 7/02

(52) U.S. Cl. CPC A47C 4/54; A47C 7/021; F16K 15/20
USPC 297/452.41; 137/224; 137/14

(57) ABSTRACT

An inflatable seat features an inflatable body having a cylindrical shape when inflated so as to visually approximate the shape of a drink can, and a seat topper situated atop the inflatable body. The seat topper features a padding layer disposed atop a base, which is of greater hardness and rigidity than the padding layer and has a flat undersurface in order to flatten out an underlying area of the top end of the inflatable to eliminate bulging of the top end of the inflatable and thereby better approximate the shape of a drink can. A pressure relief valve on the inflatable body prevents blowout of same under extreme pressure conditions when sat upon in high temperature environments.

### FIELD OF THE INVENTION

The present invention relates generally to inflatable seats, and more particularly to inflatable seats that visually approximate the shape of a conventional drinking can, for example for use at events sponsored by beverage companies.

### BACKGROUND OF THE INVENTION

In the field of advertising and promotion, it is known to provide generally cylindrical inflatable devices that, when inflated, visually approximate the shape of conventional aluminum drink cans and are printed with visual indicia reflective of the brand of beverage being promoted.

However, these items have thus far been intended only as display items, and provide no additional functional purpose beyond promoting the beverage brand or company concerned.

Separately, it has also been known to use inflatables of generally cylindrical shape to provide a collapsible, portable seating solution for temporary setup at trade shows, as exemplified by the X-Relax inflatable stool available from Skywalk GmbH & Co. KG. Other generally cylindrical inflatable seats or stools are also known. However, the existing products known to the Applicant are not intended to simulate the appearance of a beverage can.

Applicant has developed a unique inflatable seating apparatus with novel features providing improvement in both visually simulating a beverage can and providing safety to the user.

### SUMMARY OF THE INVENTION

According to a first aspect of the invention there is provided an inflatable seat apparatus comprising:

an inflatable body configured to have a cylindrical peripheral wall closing around a longitudinal axis and opposing first and second end walls in the fully inflated state so as to visually approximate the shape of a drink can when in said fully inflated state;

a seat topper for placement atop the inflatable body on the first end wall thereof when the inflatable body is in the fully inflated state and is in an upstanding position placing the longitudinal axis in an upright orientation with the first end wall situated above the second end wall, the seat topper comprising a padding layer disposed atop a seat topper base, the seat topper base being of greater hardness and rigidity than the padding layer and having a flat undersurface to flatten out an underlying area of the first end wall beneath the flat undersurface of the seat topper base.

According to a second aspect of the invention there is provided an inflatable seat apparatus comprising:

an inflatable body in an upstanding and inflated state defining a cylindrical peripheral wall closing around a longitudinal axis and opposing first and second end walls and visually approximating the shape of a drink can with the longitudinal axis in an upright orientation and the first end wall situated above the second end wall;

a seat topper disposed atop the inflatable body on the first end wall thereof, the seat topper comprising a padding layer disposed atop a seat topper base, the seat topper base being of greater hardness and rigidity than the padding layer and having a flat undersurface to flatten out an underlying area of the first end wall beneath the flat undersurface of the seat topper base.

Preferably the seat topper base comprises a planar sheet or plate.

Preferably the planar sheet or plate is circular in shape.

Preferably the planar sheet or plate is equal in diameter to the first end wall of the inflatable body.

Preferably the first end wall is smaller diameter than the second end wall, and the inflatable body has a tapered peripheral wall section joining the cylindrical peripheral wall to the first end wall.

Preferably the inflatable body comprises an air impermeable flexible skin defining the cylindrical peripheral wall and a floor base situated at the second end wall for placement on the ground to carry the flexible skin in the upright position, the floor base being of greater hardness and rigidity than the flexible skin.

Preferably the floor base is planar.

Preferably the floor base is circular in shape.

Preferably the floor base is equal in diameter to the second end wall of the inflatable body.

Preferably there is provided a pressure relief valve installed on the inflatable body and configured to open from a normally closed state to an open relief state when a predetermined pressure threshold is exceeded within an interior space of the inflatable so as to vent excess pressure from said interior space inside the inflatable body to a surrounding external environment outside said inflatable body.

According to a third aspect of the invention there is provided a method of setting up an inflatable seat comprising:

inflating an inflatable body into an inflated state having a cylindrical peripheral wall closing around a longitudinal axis and opposing first and second end walls and visually approximating the shape of a drink can;

with said inflatable body in an upstanding position placing the longitudinal axis in an upright orientation with the first end wall situated above the second end wall, placing a seat topper atop the first end of the inflatable body such that a base of said seat topper acts to flatten out an underlying area of the first end wall beneath while supporting a padding layer atop the base thereof to provide a padded seating area atop the flattened first end wall of the inflatable body.

According to a fourth aspect of the invention there is provided an inflatable seat apparatus comprising:

an inflatable body;

a pressure relief valve on the inflatable body configured to open from a normally closed state to an open relief state when a predetermined pressure threshold is exceeded within an interior space of the inflatable body so as to vent excess pressure from said interior space inside the inflatable body to a surrounding external environment outside said inflatable body.

According to a fifth aspect of the invention there is provided a method of preventing blowout of an inflatable seat, the method comprising using a pressure relief valve to automatically vent gas from an interior space of the inflatable seat when a predetermined pressure threshold is exceeded inside an interior space of said inflatable seat.

Preferably the method includes automatically venting the gas in response to increased pressure caused by exertion of a user's weight on the inflatable seat during seating of said user atop the inflatable seat.

### BRIEF DESCRIPTION OF THE DRAWINGS

In the accompanying drawings, which illustrate an exemplary embodiment of the present invention:

FIG. 1 is a schematic perspective view of an inflatable seat apparatus of the present invention.

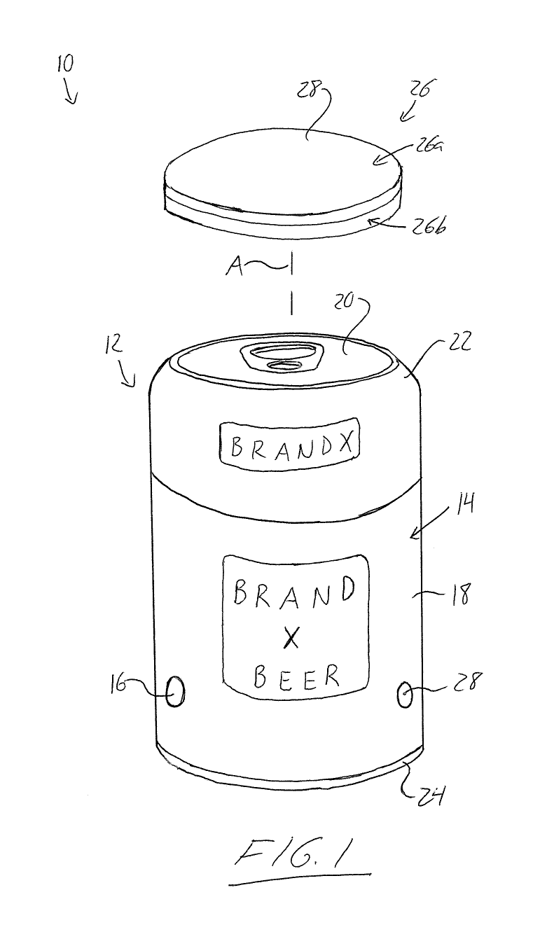

### DETAILED DESCRIPTION

The appended FIGURE illustrates an inflatable seating apparatus 10 of the present invention. An inflatable body 12 is formed of a flexible skin 14 of air impermeable material enclosing an interior space of the body. An inflation-deflation port 16 is provided at a location somewhere on the flexible skin of the material, and in a conventional manner features a closure member that normally keeps this port in a closed state forming an air-tight seal of the interior space and suitable means for selective coupling of an air pump to the port when the closure member is open, whereby the body 12 can be inflated by pumping air into the interior space. The closure member is re-closed to maintain the inflated state of the body, and when use of the apparatus is no longer required, deflation is accomplished by re-opening the closure member and allowing or forcing air out of the interior space through the open port. Such inflation ports are well known in the art, thus being only schematically illustrated herein and not described in further detail.

The FIGURE shows the body 12 in a fully inflated state, in which the flexible skin 14 defines a cylindrical peripheral wall 18, a circular top end wall 20 of slightly smaller diameter than the cylindrical peripheral wall 18, and a generally frustoconical peripheral wall section 22 that joins the cylindrical peripheral wall to the smaller diameter top end wall 20. The body 12 is shown in an upstanding position, where a longitudinal axis A around which the cylindrical wall 18 closes is oriented vertically upright, with the top end wall 20 lying generally horizontal at a short height above the upper end of the cylindrical wall 18. The larger diameter lower end of the frusto-conical wall section 22 extends from the top end of the cylindrical wall 18, from where the frustoconical wall section 20 then tapers in diameter moving upwardly toward where it joins to the circumference of the circular top end wall 20.

A relatively hard, rigid floor base 24 is provided in the form of a flat circular disc of plate or sheet material, for example formed by a sheet of wood or rigid plastic, and is coupled to the flexible skin of the inflatable body at the bottom end of the cylindrical peripheral wall 18. The body may include a circular bottom wall of the flexible skin material that spans the lower end of the cylindrical wall 18, whereby the interior space of the inflatable body is bound on all sides by the flexible skin material, in which case the floor base may be adhered or otherwise fastened to the flexible skin material a bottom surface of the bottom wall facing outward from the interior of the inflatable body. Alternatively, a flexible bottom wall may be omitted, with the rigid floor base 24 instead being adhered to the flexible material of the cylindrical wall 18 in a suitable air tight manner, whereby the floor base 24 itself forms the bottom wall of the inflatable body's interior space.

Alternatively, another embodiment may feature a bottom wall of the flexible skin material, but have the floor base 24 disposed at the inner surface of this bottom wall, i.e. having sealed up the flexible skin material only after such placement of the floor base during manufacture. However, one advantage of an externally located floor base, even when a flexible-skin bottom wall is present for air-tight closure of the bottom end of the inflatable interior space, is that only the base contacts the ground or floor, thus avoiding puncture or wear to the softer flexible skin material by any sharp objects or surface irregularities on the ground or floor. Such an external floor base situated outside the inflatable interior of the body is preferably a solid disc, i.e. not having any voids or openings through its thickness at any point across any diameter line thereof, and preferably spans the full diameter of the cylindrical wall 18, thus providing such puncture protection across the entire footprint of the inflatable body.

The flat bottom surface of the floor-base provides a stable, hard, rigid surface for seating the inflatable body on the ground or floor, thereby providing stability by resisting any tipping-over tendency that may otherwise be prevalent if no such rigid reinforcement was provided at the bottom of the inflatable body.

A seat topper 26 is provided for placement on the upward-facing outer surface of the top wall 20 of the inflatable body. The seat topper 26 features a two layer composition, in which an upper padding layer 26a features foam or other cushioning material disposed atop a relatively hard and rigid base layer 26b. The foam may be contained and protected by suitable fabric cover material 28. The covered padding layer that forms a seat cushion on which a user of the inflatable seat can comfortably sit, while the base layer provides a flat-bottomed, hard rigid base for flattening out any bulging tendency of the top wall 20 of the inflated body 12.

The seat topper base 26b may be of similar form to the floor base, particularly a flat circular disc of plate or sheet-like planar structure, for example cut from a wooden board or sheet or formed as a molded plastic disc. The seat topper base disc 26b fully or substantially spans the entire area of the top wall 20, for example as a result of having the same diameter as the top wall. The planar underside of the seat topper base disc 26b thus acts to distribute the weight of the seat topper over the top end of the inflatable body, thus flattening out any concave bulging tendency of the top wall 20 when the body is fully inflated. This way, an elevational side view of the inflated body reveals a planar upper end of the body, thus more accurately reflecting the shape of a conventional beverage can than a concavely bulged top end.

The rigidly flat form of the seat topper base 26b provides the suitable form for flattening out the top of the inflatable body, and provides weight to contribute to flattening of the topside of the inflatable body, which is further contributed to by the weight of a user who subsequently sits on the padding layer 26a of the seat topper. The flattening of the top end of the inflatable body increases the pressure inside the inflatable body, which provides firm support to the seat topper over the full diameter of the top wall of the inflatable body. Due to its rigid base layer, the seat topper provides a more stable seating surface than sitting directly upon the inflatable, as the flat underside of the seat topper means that any compression of the top end of the inflatable body when the user sits on the apparatus will occur uniformly over the inflatable body, rather than having the top wall deform non-uniformly according to the contours of the user's body.

A pressure relief valve, schematically shown at 28 is installed in an opening of the flexible skin of the inflatable embody. The valve is configured to normally be in a closed state maintaining the air-tight sealed condition of the interior space of the inflatable body relative to the external environment surrounding same, and only opens when the pressure inside the inflatable exceeds a predetermined threshold, beyond which a blowout of the inflatable body may present a safety risk. Pressure relief valves are well known and commercially available, and so the structural and operational details of same are not reproduced herein.

It will be appreciated that sponsored events at which branded, portable seating may be employed are often held outdoors in warm climates or seasons. Accordingly, sitting outside at a position exposed to sunlight, the inflatable body will be subject to increasing temperature of the air within the body's interior space, thus increasing the pressure inside this space. The internal pressure further increases when a user sits atop the apparatus, due to the downward compression of the top end of the inflatable body under the user's body weight. Accordingly, by selecting a pressure relief valve that will vent air to the external environment above a safe threshold value, the blowout risk under such high-pressure conditions is avoided.

As shown in the FIGURE, the flexible skin of the inflatable body may be printed, or otherwise equipped, with branding indicia or other visually readable/recognizable promotional material, for example with printing or labels that simulate the appearance of a particular brand of beverage can. Together with possible use of differently coloured areas on the flexible skin of the inflatable body, the appearance of such a beverage container can be accurately simulated by the inflatable apparatus of the present invention.

In a deflated state, the flexible skin cylindrical wall 18 of the inflatable body can be collapsed down to bring the top wall 20 down to the near the floor base to lie generally parallel thereto, and for example held down in such a condition by storage of the seat topper on top. A transport bag may be provided for containing the collapsed deflated body and the seat topper. For use at a subsequent event, the inflatable body is removed from the bag and inflated, and the seat topper placed atop the body.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. An inflatable seat apparatus comprising:
an inflatable body configured to have a cylindrical peripheral wall closing around a longitudinal axis and opposing first and second end walls in the fully inflated state so as to visually approximate the shape of a drink can when in said fully inflated state;
a seat topper situated or situatable atop the inflatable body on the first end wall thereof when the inflatable body is in the fully inflated state and is in an upstanding position placing the longitudinal axis in an upright orientation with the first end wall situated above the second end wall, the seat topper comprising a padding layer disposed atop a seat topper base, the seat topper base being of greater hardness and rigidity than the padding layer and having a flat undersurface to flatten out an underlying area of the first end wall beneath the flat undersurface of the seat topper base.

2. The inflatable seat of claim 1 wherein the seat topper base comprises a planar sheet or plate.

3. The inflatable seat of claim 2 wherein the planar sheet or plate is circular in shape.

4. The inflatable seat of claim 3 wherein the planar sheet or plate is equal in diameter to the first end wall of the inflatable body.

5. The inflatable seat claim 1 wherein the first end wall is smaller diameter than the second end wall, and the inflatable body has a tapered peripheral wall section joining the cylindrical peripheral wall to the first end wall.

6. The inflatable seat of claim 1 wherein the inflatable body comprises an air impermeable flexible skin and a floor base situated at the second end wall, the floor base being of greater hardness and rigidity than the flexible skin.

7. The inflatable seat of claim 6 wherein the floor base is planar.

8. The inflatable seat of claim 7 wherein the floor base is circular in shape.

9. The inflatable seat of claim 8 wherein the floor base is equal in diameter to the second end wall of the inflatable body.

10. The inflatable seat of claim 1 comprising a pressure relief valve installed on the inflatable body and configured to open from a normally closed state to an open relief state when a predetermined pressure threshold is exceeded within an interior space of the inflatable so as to vent excess pressure from said interior space inside the inflatable body to a surrounding external environment outside said inflatable body.

11. A method of setting up an inflatable seat comprising:
inflating an inflatable body into an inflated state having a cylindrical peripheral wall closing around a longitudinal axis and opposing first and second end walls and visually approximating the shape of a drink can;
with said inflatable body in an upstanding position placing the longitudinal axis in an upright orientation with the first end wall situated above the second end wall, placing a seat topper atop the first end of the inflatable body such that a base of said seat topper acts to flatten out an underlying area of the first end wall beneath while supporting a padding layer atop the base thereof to provide a padded seating area atop the flattened first end wall of the inflatable body.

12. An inflatable seat apparatus comprising:
an inflatable body;
a pressure relief valve on the inflatable body configured to open from a normally closed state to an open relief state when a predetermined pressure threshold is exceeded within an interior space of the inflatable body so as to vent excess pressure from said interior space inside the inflatable body to a surrounding external environment outside said inflatable body.

13. A method of preventing blowout of an inflatable seat, the method comprising using a pressure relief valve to automatically vent gas from an interior space of the inflatable seat when a predetermined pressure threshold is exceeded inside an interior space of said inflatable seat.

14. The method of claim 13 comprising automatically venting the gas in response to increased pressure caused by exertion of a user's weight on the inflatable seat during seating of said user atop the inflatable seat.
